(19) United States
(12) Patent Application Publication
(10) Pub. No.: US 2012/0195423 A1
(43) Pub. Date: Aug. 2, 2012

(54) SPEECH QUALITY ENHANCEMENT IN TELECOMMUNICATION SYSTEM

(75) Inventor: Seungil Kim, Seoul (KR)

(73) Assignee: EMPIRE TECHNOLOGY DEVELOPMENT LLC, Wilmington, DE (US)

(21) Appl. No.: 13/142,048

(22) PCT Filed: Jan. 31, 2011
(86) PCT No.: PCT/US11/23203

§ 371 Date: Jun. 24, 2011

(51) Int. Cl. H04M 9/08

(52) U.S. Cl. 379/406.01

(57) ABSTRACT

Technologies are generally described for an echo cancelling device of a telecommunication system. In some examples, an echo canceling device may include a noise reduction unit configured to reduce a background noise around a near-end talker from a near-end signal provided by a microphone, a double talk detector configured to detect a double talk event based on the noise-reduced near-end signal and a far-end signal, and a filtering unit configured to receive the far-end signal and the near-end signal provided by the microphone.

### BACKGROUND

Acoustic echo arises when sound from a speaker is picked up by a microphone due to acoustic reflections. The acoustic echo may exist in any communications scenario where there is a speaker and a microphone, such as in a hands-free phone, a conference phone, and a standard and/or cellular phone having a speakerphone mode or hands-free mode. An acoustic echo canceller (AEC) is generally employed in a telecommunication system to enhance the speech quality by reducing acoustic echo.

Typically, an acoustic echo canceller (AEC) employed in a telecommunication system includes an adaptive filter and a double talk detector configured to detect a double talk event between a near-end talker and a far-end talker and to freeze the adaptive filter when detecting the double talk event. Since most of the AEC-equipped products are designed to substantially support half-duplex operating mode, voice discontinuity occurs when a double talk event is detected.

In a noisy environment, for example, in a loud café or on a noisy street, a double talk event can be caused by the noise around a near-end talker, even in case where the near-end talker does not speak. Specifically, when a near-end talker is silent but in a noisy environment, once a far-end talker starts to speak, a double talk event can be detected by a double talk detector. In case that the AEC is substantially configured to support half-duplex operating mode as discussed above, the double talk event induces the voice discontinuity. That is, the user in the noisy environment has to bear with the inconvenience of the voice discontinuity of the other party of the call. To make this problem worse, if the far-end talker is in a noisy environment as well, the call will be in a double talk situation at virtually all times and the voice discontinuity will become worse. As such, the voice discontinuity problems can be caused and even become worse by the false alarm from the double talk detector due to the background noise. In this regard, resolving such problems would enhance the end-to-end speech quality.

### SUMMARY

In an example, an echo canceling device may include a noise reduction unit configured to reduce a background noise around a near-end talker from a near-end signal provided by a microphone, a double talk detector configured to detect a double talk event based on the noise-reduced near-end signal and a far-end signal, and a filtering unit configured to receive the far-end signal and the near-end signal provided by the microphone.

In an example, a telecommunication terminal may include a microphone configured to detect a sound of a near-end talker and a background noise around the near-end talker, a speaker configured to reproduce a far-end signal, and an echo canceling device configured to include a noise reduction unit configured to reduce the background noise around the near-end talker from a near-end signal provided by the microphone, a double talk detector configured to detect a double talk event based on the noise-reduced near-end signal and the far-end signal, and an adaptive filter configured to provide a replica of an echo signal based on the near-end signal provided by the microphone and the far-end signal.

In an example, a method performed under control of an echo canceling device may include reducing a background noise around a near end talker from a near-end signal provided by a microphone, detecting a double talk event based on the noise-reduced near-end signal and a far-end signal, and generating a replica of an echo signal based on the near-end signal provided by the microphone and the far-end signal.

In an example, a computer-readable storage medium whose contents, when executed by a processor, cause the processor to reduce a background noise around a near-end talker from a near-end signal provided by a microphone, detect a double talk event based on the noise-reduced near-end signal and a far-end signal, and provide a replica of an echo signal based on the near-end signal provided by the microphone and the far-end signal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows a schematic block diagram of an illustrative example of a telecommunication terminal;

FIG. 2 shows a schematic block diagram of an illustrative example of a telecommunication terminal with a second noise reduction unit;

FIG. 3 shows a schematic block diagram of an illustrative example of a filtering unit illustrated in FIGS. 1 and 2;

FIG. 4 shows an example flow diagram of a method for echo canceling.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to enhancement of a speech quality of a telecommunication system.

Briefly stated, technologies are generally described for an echo cancelling device of a telecommunication system. In some examples, the device includes a noise reduction unit configured to reduce a background noise around a near-end talker from a near-end signal provided by a microphone. In some examples, the device includes a double talk detector configured to detect a double talk event based on the noise-reduced near-end signal and a far-end signal. In some examples, the device includes a filtering unit configured to receive the far-end signal and the near-end signal provided by the microphone.

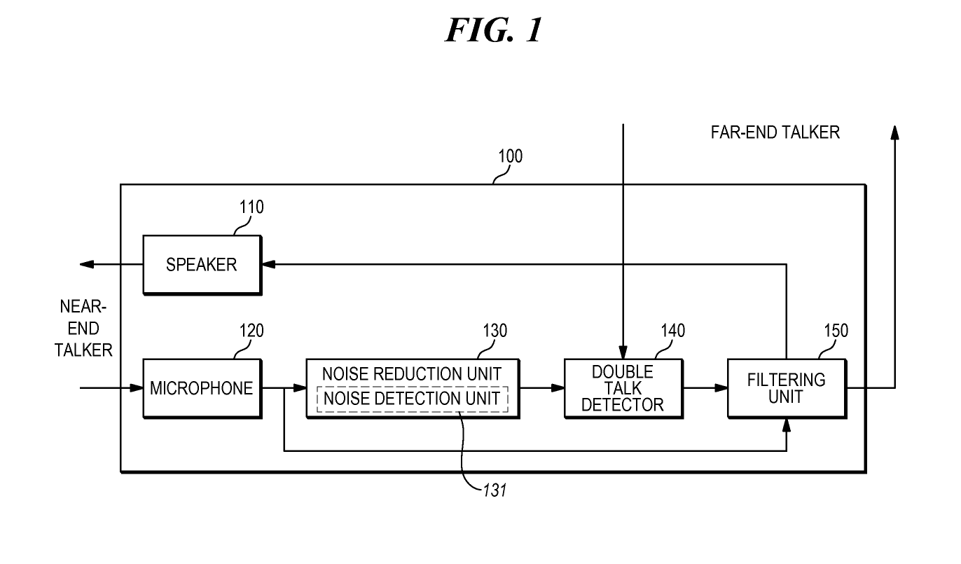

FIG. 1 shows a schematic block diagram of an illustrative example of a telecommunication terminal in accordance with at least some embodiments described herein.

Referring to FIG. 1, a telecommunication terminal 100 may include a speaker 110. Speaker 110 may output an audible signal originated from the other party of a call, i.e., a far-end talker. Speaker 110 may include, but not limited to, a speaker embedded in the terminal, a headphone speaker connectable to the terminal, or an earphone speaker connectable to the terminal.

Telecommunication terminal 100 may further include a microphone 120. Microphone 120 may detect a sound from an ambient environment around microphone 120. By way of example, but not limitation, microphone 120 may receive a voice signal from a user of telecommunication terminal 100, i.e., a near-end talker. Microphone 120 may also receive a background noise signal around the near-end talker.

Telecommunication terminal 100 may further include a noise reduction unit 130. Noise reduction unit 130 may receive the signal output from microphone 120, and reduce the background noise signal from the signal received from microphone 120. By way of example, but not limitation, noise reduction unit 130 may detect the background noise signal around telecommunication terminal 100, and subtract the detected background noise signal from the signal received from microphone 120. In some embodiments, noise reduction unit 130 may include a noise detecting unit (not shown) configured to detect the background noise. Alternatively, telecommunication terminal 100 may include the noise detecting unit separately from noise reduction unit 130.

In some embodiments, noise reduction unit 130 may use a single-channel noise reduction algorithm. By way of example, but not limitation, the single-channel noise reduction algorithm may include at least one selected from a group consisting of a spectral subtraction algorithm, a minimum mean square error algorithm, and a Wiener filter algorithm. In some embodiments, noise reduction unit 130 may use a multi-channel noise reduction algorithm if a plurality of microphones are employed in a system.

In some embodiments where noise reduction unit 130 uses a spectral subtraction algorithm, noise reduction unit 130 may include an analogue-to-digital (A/D) converter (not shown) to convert the signal from microphone 120 into a digital signal. The digital signal in time domain may then be transformed to frequency domain signal. By way of example, but not limitation, the transformation into frequency domain may be carried out using a fast Fourier transform (FFT). In frequency domain, the background noise may be distinguished from the voice signal, and the background noise may be removed. In some embodiments, the frequency domain signal may be transformed to time domain noise-reduced signal by using an inverse fast Fourier transform (IFFT).

Referring to FIG. 1 again, telecommunication terminal 100 may further include a double talk detector 140. Double talk detector 140 may receive the signal output from noise reduction unit 130 and the signal originated from the far-end talker, and detect a double talk event between the near-end talker and the far-end talker. Double talk detector 140 may detect the double talk event when the signal from noise reduction unit 130 exists and temporally overlaps the signal from the far-end talker. Since the signal output from noise reduction unit 130 may include the voice signal of the near-end talker with the background noise being reduced as discussed above, the double talk event caused by the background noise around telecommunication terminal 100 may be reduced, compared to the case where noise reduction unit 130 does not exist at the front end of double talk detector 140.

Telecommunication terminal 100 may further include a filtering unit 150. Filtering unit 150 may receive the signal output from microphone 120 and the signal originated from the far-end talker, estimate an echo signal, and subtract the estimated replica of the echo signal from the signal output from microphone 120, to provide an echo-free signal to the far-end talker. In some embodiments, the echo-free signal output from filtering unit 150 may feed again to filtering unit 150, to update the filter coefficients for adaptive filtering. It should be noted that filtering unit 150 may use the signal output from microphone 120, rather than the noise-reduced signal, i.e., the signal output from noise reduction unit 130, thereby avoiding a problem of distortion in echo estimation due to the non-linearity caused by noise reduction unit 130.

In some embodiments, filtering unit 150 may further receive from double talk detector 140 an indication signal indicating whether double talk detector 140 detects the double talk event. In some embodiments, when the indication signal indicates that double talk detector 140 detects the double talk event, filtering unit 150 may be freezed, that is, stop to update the filter coefficients.

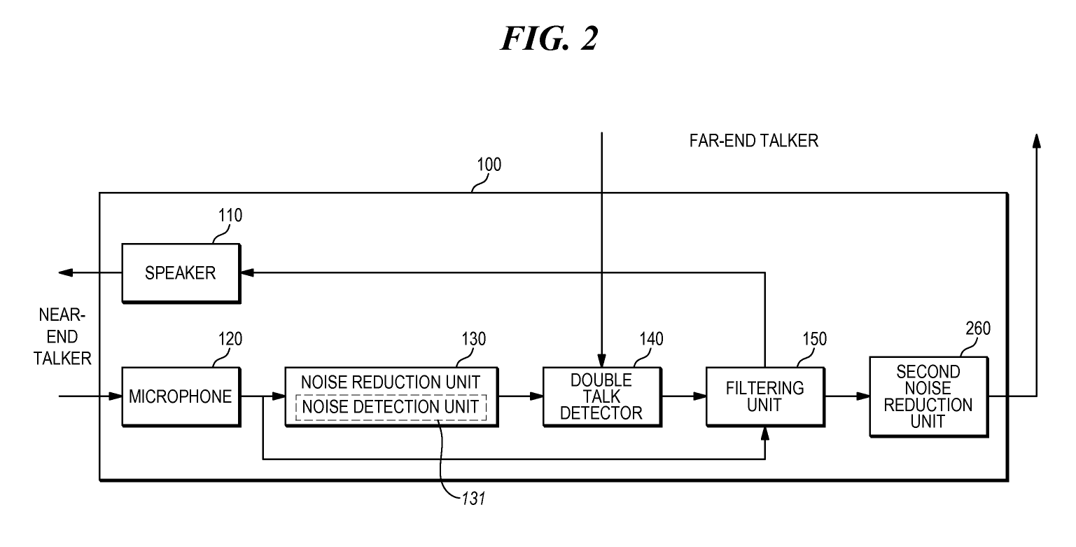

FIG. 2 shows a schematic block diagram of another illustrative example of a telecommunication terminal in accordance with at least some embodiments. Referring to FIG. 2, telecommunication terminal 100 may further include a second noise reduction unit 260. Second noise reduction unit 260 may receive the signal output from filtering unit 150, and reduce a noise from the signal output from filtering unit 150. Second noise reduction unit 260 may eliminate noise from the signal output from filtering unit 150, so that the sound quality experienced by the far-end talker may be improved.

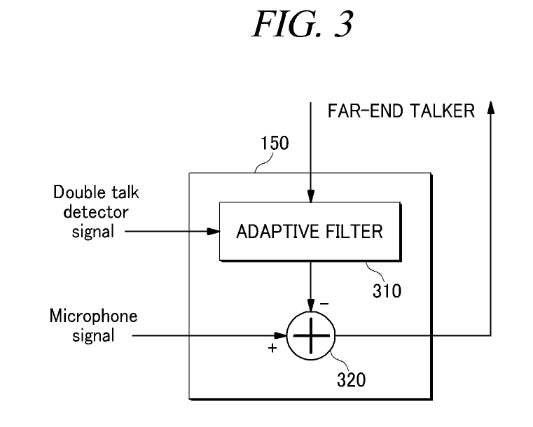

FIG. 3 shows a schematic block diagram of an illustrative example of filtering unit 150 illustrated in FIGS. 1 and 2. Filtering unit 150 may include an adaptive filter 310 and a subtracter 320.

Referring to FIGS. 1 to 3, by way of example, but not limitation, adaptive filter 310 may receive the signal originated from the far-end talker, estimate an echo signal and provide a replica of the echo signal to subtracter 320. In some embodiments, adaptive filter 310 may receive from double talk detector 140 an indication signal indicating whether double talk detector 140 detects the double talk event. In some embodiments, when the indication signal indicates that double talk detector 140 detects the double talk event, adaptive filter 310 may be freezed, that is, the filter coefficients of adaptive filter 310 may stop to be updated.

Subtracter 320 may receive the signal output from microphone 120 and the replica of the echo signal from adaptive filter 310, and subtract the replica of the echo signal from the signal output from microphone 120, to provide an echo-free signal to the far-end talker. It should be noted that subtracter 320 may receive the signal output from microphone 120, rather than the noise-reduced signal, i.e., the signal output from noise reduction unit 130, thereby avoiding a problem of distortion in echo estimation due to the non-linearity caused by noise reduction unit 130.

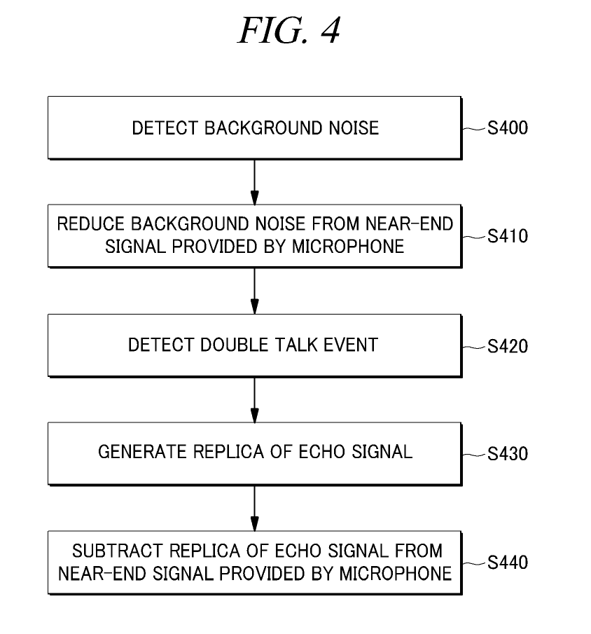

FIG. 4 shows a flow diagram of a method for echo canceling in accordance with at least some embodiments described herein. The method in FIG. 4 could be implemented using, for example, the telecommunication terminal including the echo canceling device discussed above. An example method may include one or more operations, actions, or functions as illustrated by one or more of blocks S400, S410, S420, S430 and/or S440. Although illustrated as discrete blocks, various blocks may be divided into additional blocks, combined into fewer blocks, or eliminated, depending on the desired implementation.

At block S400, the telecommunication terminal may detect background noise around the telecommunication terminal from a near-end signal provided by a microphone. By way of example, but not limitation, a noise reduction unit in the telecommunication terminal may detect the background noise around the telecommunication terminal. By way of example, but not limitation, a noise detecting unit in or outside of the noise reduction unit may detect the background noise around the telecommunication terminal.

At block S410, the telecommunication terminal may reduce the background noise around the telecommunication terminal from the near-end signal provided by the microphone. By way of example, but not limitation, the noise reduction unit in the telecommunication terminal may reduce the background noise around the telecommunication terminal from the near-end signal provided by the microphone. In some embodiments, the noise reduction unit may use a single-channel noise reduction algorithm. By way of example, but not limitation, the single-channel noise reduction algorithm may include at least one selected from a group consisting of a spectral subtraction algorithm, a minimum mean square error algorithm, and a Wiener filter algorithm. In some embodiments, the noise reduction unit may use a multi-channel noise reduction algorithm if a plurality of microphones are employed in a system.

At block S420, the telecommunication terminal may detect a double talk event based on the noise-reduced near-end signal and a far-end signal from a far-end talker. By way of example, but not limitation, a double talk detector may detect double talk event based on the noise-reduced near-end signal provided by the noise reduction unit and the far-end signal. Since the double talk detection is conducted based on the noise-reduced near-end signal, the detection of the double talk event due to the background noise around telecommunication terminal may be reduced, compared to the case where the double talk detection is conducted based on the near-end signal directly provided by the microphone.

At block S430, the telecommunication terminal may generate a replica of an echo signal based on the near-end signal provided by the microphone and the far-end signal. By way of example, but not limitation, a filtering unit in the telecommunication terminal may estimate the echo signal and generate the replica of the echo signal. By way of example, but not limitation, an adaptive filter in the filtering unit may generate the replica of the echo signal.

At block S440, the telecommunication terminal may subtract the replica of the echo signal from the near-end signal provided by the microphone, to provide an echo-free signal to the far-end talker. By way of example, but not limitation, a filtering unit in the telecommunication terminal may subtract the replica of the echo signal from the near-end signal provided by the microphone. By way of example, but not limitation, a subtracter may receive the near-end signal provided by the microphone and the replica of the echo signal from the adaptive filter, and subtract the replica of the echo signal from the near-end signal provided by the microphone. Since the subtracter may use the signal output from the microphone, rather than the noise-reduced signal, a problem of distortion in echo estimation due to the non-linearity caused by the noise reduction process may be avoided.

Although not illustrated in FIG. 4, the telecommunication terminal may further reduce a noise from the echo-free signal. By way of example, but not limitation, a second noise reduction unit in the telecommunication terminal may reduce a noise from the echo-free signal provided by the filtering unit. By reducing the noise from the echo-free signal to be sent to the far-end talker, the far-end talker may experience a better quality of the sound.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An echo canceling device comprising:
a noise reduction unit configured to reduce a background noise around a near-end talker from a near-end signal provided by a microphone;
a double talk detector configured to detect a double talk event based on the noise-reduced near-end signal and a far-end signal and to generate an indication signal indicating whether the double talk detector detects the double talk event; and
a filtering unit configured to receive the far-end signal and the near-end signal provided by the microphone and comprising an adaptive filter configured to receive only the far-end signal and the indication signal.

2. (canceled)

3. The echo canceling device of claim 1, wherein the filtering unit further comprising:
a subtracter configured to receive the near-end signal provided by the microphone and a replica of the echo signal generated by the adaptive filter, and
wherein the subtracter is further configured to provide an echo-free signal.

4. The echo canceling device of claim 3, further comprising:
a second noise reduction unit configured to receive the echo-free signal and to reduce a noise from the echo-free signal.

5. The echo canceling device of claim 1, further comprising:
a noise detecting unit configured to detect the background noise around the near-end talker.

6. The echo canceling device of claim 1, wherein the filtering unit is further configured to receive from the double talk detector the indication signal.

7. The echo canceling device of claim 6, wherein the filtering unit is further configured to be frozen when the indication signal indicates that the double talk detector detects the double talk event.

8. The echo canceling device of claim 1, wherein the noise reduction unit is further configured to use a single-channel noise reduction algorithm.

9. The echo canceling device of claim 8, wherein the single-channel noise reduction algorithm includes at least one selected from a group consisting of a spectral subtraction algorithm, a minimum mean square error algorithm, and a Wiener filter algorithm.

10. The echo canceling device of claim 1, wherein the noise reduction unit is further configured to use a multi-channel noise reduction algorithm.

11. The echo canceling device of claim 1, further comprising:
a second noise reduction unit configured to reduce a noise from the output signal of the filtering unit.

12. A telecommunication terminal comprising:
a microphone configured to detect a sound of a near-end talker and a background noise around the near-end talker;
a speaker configured to reproduce a far-end signal; and
an echo canceling device comprising:
a noise reduction unit configured to reduce the background noise around the near-end talker from a near-end signal provided by the microphone;
a double talk detector configured to detect a double talk event based on the noise-reduced near-end signal and the far-end signal and to generate an indication signal indicating whether the double talk event is detected; and
an adaptive filter configured to provide a replica of an echo signal based only on the far-end signal and the indication signal.

13. The telecommunication terminal of claim 12, wherein the echo canceling device further comprises:
a subtracter configured to subtract the replica of the echo signal from the near-end signal provided by the microphone to provide an echo-free signal.

14. The telecommunication terminal of claim 13, wherein the echo canceling device further comprising:
a second noise reduction unit configured to reduce a noise from the echo-free signal.

15. The telecommunication terminal of claim 12, wherein the echo canceling device further comprising:
a noise detecting unit configured to detect the background noise around the near-end talker.

16. (canceled)

17. The telecommunication terminal of claim 12, wherein the adaptive filter is further configured to be frozen when the indication signal indicates that the double talk detector detects the double talk event.

18. The telecommunication terminal of claim 12, wherein the noise reduction unit is further configured to use a single-channel noise reduction algorithm.

19. The telecommunication terminal of claim 18, wherein the single-channel noise reduction algorithm includes at least one selected from a group consisting of a spectral subtraction algorithm, a minimum mean square error algorithm, and a Wiener filter algorithm.

20. The telecommunication terminal of claim 12, wherein the noise reduction unit is further configured to use a multi-channel noise reduction algorithm.

21. A method performed under control of an echo canceling device, comprising:
reducing a background noise around a near-end talker from a near-end signal provided by a microphone;
detecting a double talk event based on the noise-reduced near-end signal and a far-end signal;
generating an indication signal indicating whether the double talk event is detected; and
generating a replica of an echo signal based only on the indication signal and the far-end signal.

22. The method of claim 21, further comprising:
subtracting the replica of the echo signal from the near-end signal provided by the microphone to provide an echo-free signal.

23. The method of claim 22, further comprising:
reducing a noise from the echo-free signal.

24. The method of claim 21, further comprising:
detecting the background noise around the near-end talker.

25. The method of claim 21, wherein the reducing the background noise from the near-end signal comprises reducing the background noise by using a single-channel noise reduction algorithm.

26. The method of claim 25, wherein the single-channel noise reduction algorithm includes at least one selected from a group consisting of a spectral subtraction algorithm, a minimum mean square error algorithm, and a Wiener filter algorithm.

27. The method of claim 21, wherein the reducing the background noise from the near-end signal comprises reducing the background noise by using a multi-channel noise reduction algorithm.

28. A non-transitory computer-readable storage medium whose contents, when executed by a processor, cause the processor to:
reduce a background noise around a near-end talker from a near-end signal provided by a microphone;
detect a double talk event based on the noise-reduced near-end signal and a far-end signal and generate an indication signal indicating detection of the double talk event; and
provide a replica of an echo signal based only on the indication signal and the far-end signal.
